(19) United States
(12) Patent Application Publication
(10) Pub. No.: US 2019/0216173 A1
(43) Pub. Date: Jul. 18, 2019

(54) Adherable Footwear Cushion

(71) Applicant: I-Hui Chao, Fort Worth, TX (US)

(72) Inventor: I-Hui Chao, Fort Worth, TX (US)

(21) Appl. No.: 15/871,832

(22) Filed: Jan. 15, 2018

(51) Int. Cl. A43B 17/18; A43B 17/00; A43B 17/14; B32B 5/02; B32B 5/18; B32B 5/24; B32B 27/12; B32B 27/06; B32B 27/40; B32B 7/12

(52) U.S. Cl. CPC A43B 17/18; A43B 17/006; A43B 17/14; B32B 5/02; B32B 5/18; B32B 2437/02; B32B 27/12; B32B 27/065; B32B 27/40; B32B 7/12; B32B 5/245

(57) ABSTRACT

An adherable footwear cushion, comprises a supporting layer, an adhesive layer, and a medium layer. The adhesive layer help to combine the supporting layer and the adhesive layer together to make the footwear cushion adherable, detachable, and reusable.

### BACKGROUND

### 1. Field of the Invention

The present invention relates to a footwear cushion. More particularly, the footwear cushion is adherable to the shoe and can be detached without damaging the shoe.

### 2. Discussion of the Related Art

In modern days, shoes are performing more as a fashion element than just protecting feet. Therefore most of the designs will sacrifice the comfort and health to pursuit the aesthetic results. High heel is the most obvious example. When wearing high heels, the alignment of the muscles and joints is changed, and the weight of the whole body is focused on a small portion of the feet. In a short term, it will cause instant hurt and pain. But in long term, it can affect in more ways on spine, hips, knees, ankles and feet. One of them is wearing away the fat pad on the bottom of the foot which is also called foot's natural cushioning.

Not just high heels, an improperly fitted shoe can also cause the unhealthy effects. But the problem is everybody's feet are different, while the footwear industry only provides several sizes for options, and takes limited efforts to resemble each individual shape of the foot for the cost issue.

Another issue is the weight of the people. In recently years, more and more people are getting over weighted. As a result, their feet have to bear more pressure by the limited area of the sole. But most shoes have not been designed to adapt this trend, the wearer will feel hurt walking and standing with these shoes.

One simple but efficient solution to make a shoe more comfortable or less hurt is using footwear cushions and insoles. A properly applied insole can provide more support to the foot, absorb shock, prevent foot shifting in the shoe, est.

But many shoes have no enough upper structure to hold an insole, for example, the sandals. Also some shoe cushions need to be applied on portion of the lining of the shoe, such as upper or toe cap, this portion can't hold the cushion by itself. Therefore insole or cushion needs to be fixed on the sole of the shoe.

In some cases, adhesion is a solution. Some people just simply apply double-side tape to stick the insole in the position. There are many problems with this kind of cushions and insoles of prior arts. In order to fix the cushion on the shoe tightly, the cushion can't be detached easily once applied. As a result, the users need to be very careful, since they can't change the position if they apply the cushion to a wrong place. Second, while the shoe is wearing, the shape will be changed and the place needs to be cushioned may change, but the cushion is fixed and can't be adjusted. Third, the cushion can't be shared by different shoes. The users have to buy addition cushion for their new shoes. This increases the cost. Sometimes users may change their minds and don't need the cushion on their shoes. But once they removed the applied cushion they may find that not only the cushion is not reusable, but the remaining of the cushion on the shoe is sticky and hard to clean, or even damage the much more expensive shoes.

Material is also an issue affects the function of the cushion and insole. Most of plastic materials used for cushion and insole, such as TPE, PU, EVA and foam, are very difficult to apply glue or tape on them directly. Therefore they can't be made adhesive to stick on the sole.

Considering all these disadvantages mentioned above, it would be desirable to provide a footwear cushion which is detachable and reusable.

### BRIEF SUMMARY OF THE INVENTION

The primary objective of the present invention is to develop a footwear cushion which is able to be attached to the footwear and is also detachable.

Another objective of the present invention is to develop a footwear cushion which is reusable.

Another objective of the present invention is to develop a footwear cushion which has no remaining when detached from the footwear.

Another objective of the present invention is to develop a footwear cushion which is cost efficient and easy to make.

The solution provided by the present invention is to apply a medium layer between the supporting layer and the adhesive layer. The medium layer is made of materials which can be fixed on the bottom of the supporting layer, and can be applied with glue to form the adhesive layer thereon. In this way the adhesive layer and the supporting layer are combined together, so the supporting layer can be stuck onto the desired place of the sole.

The invention comprises the following, in whole or part:

A supporting layer having a bottom surface and a top surface supporting a portion of the foot; a medium layer having a first side and a second side, wherein the first side is fixed to the bottom surface of the supporting layer; and a adhesive layer attached to the second side of the medium layer, wherein the medium layer can be detachably attached to a portion of the sole.

The invention comprises the steps of manufacturing adherable footwear cushion:

(a) forming a supporting layer;
(b) forming a medium layer on the bottom surface of the supporting layer; and
(c) applying adhesive material on the surface of the medium layer to form a adhesive layer.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view illustrating a adherable footwear cushion adhered on the sole of a shoe.

FIG. 2 is a schematic sectional view of an preferred embodiment of the invention.

FIG. 3 is a schematic sectional view of an alternative embodiment of the invention.

FIG. 4 illustrates a process of manufacture of the preferred embodiment of the invention.

### DETAILED DESCRIPTION OF THE INVENTION

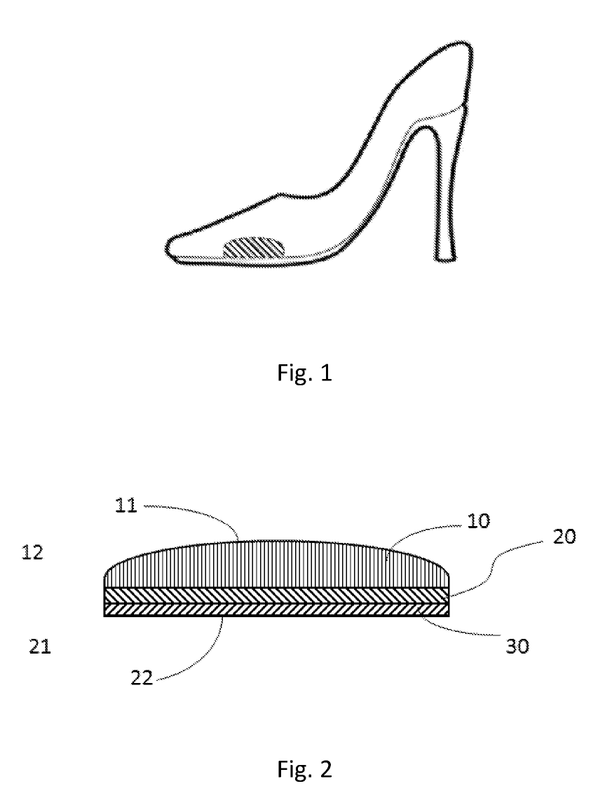

In accordance with the present invention, FIG. 1 and FIG. 2 depict a preferred embodiment of the invention. Referring to FIG. 2, the adherable footwear cushion comprises a supporting layer 10, a medium layer 20, and an adhesive layer 30.

The supporting layer 10 is made of elastic materials for cushioning. Usually it is formed as a pad with a predetermined thickness and shape. Referring to FIG. 1, the shape could be the same as the inner sole of a shoe; or it could be a particular shape for supporting a special portion of the foot. For example, the shape of the supporting layer 10 could be adapted to support the heel, the toes, or the pad of the foot.

In the preferred embodiment, the materials of making the supporting layer 10 is plastic, including but not limited to: TPE (Thermoplastic Elastomers), PU (Polyurethane), and EVA (Ethylene Vinyl Acetate).

The supporting layer 10 has two surfaces: a top surface 11, and a bottom surface 12. The top surface 11 will contact with the foot of the user, and the bottom surface 12 will be facing the footwear and will be attached to the insole of it.

The medium layer 20 of the adherable footwear cushion is a thin layer having a first side 21 and a second side 22. The first side 21 of the medium layer 20 is fixed on the surface of the supporting layer 10. Referring to FIG. 2, the medium layer 20 covers the whole area of the bottom surface 12 of the supporting layer 10. Alternatively, the medium layer 20 may cover a portion of the bottom surface 12 of the supporting layer 10. Alternatively, the medium layer 20 many also cover a portion or whole top surface 11 of the supporting layer 10.

In the preferred embodiment of the present invention, the medium layer 20 is made of TPU (Thermoplastic Polyurethane). TPU can be injected onto many materials to form a thin layer, including the materials used to form the supporting layer 10. The combination of the TPU with the supporting layer 10 could be very strong.

The adhesive layer 30 is a thin layer of glue or adhesive material, such as different kinds of pressure sensitive adhesives. In the preferred embodiment, the adhesive material is silicon pressure sensitive adhesive. The adhesive material is applied to the second side 22 of the medium layer 20 and remains thereon to form a thin adhesive layer 30. This adhesive layer 30 can attach the supporting layer 10 onto the desired location of the shoe through the medium layer 20, and prevent the supporting layer 10 to move away by the pressure from the foot. Also, the adhesive layer 30 can be peeled away from the shoe with the supporting layer 10 and the medium layer 20 without leaving remaining on the shoe. In addition, the adhesive layer 30 can be stuck onto the shoe multiple times, therefore the footwear cushion can be reused. Also, the whole footwear cushion can be washed by water.

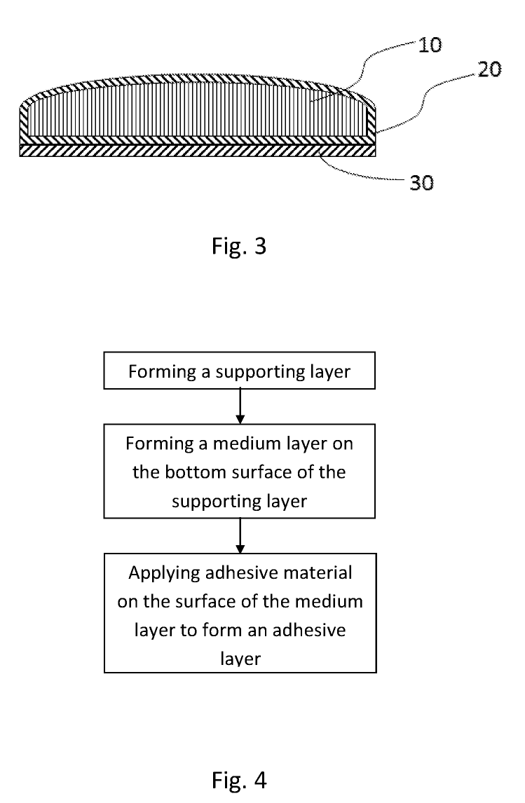

In an alternative embodiment, the material of the supporting layer 10 is foam. And the medium layer 20 is made by textile, such as cloth. Referring to FIG. 3, the textile covers both the top surface 11 and the bottom surface 12 of the supporting layer 10, and is sewn to enclose the whole supporting layer 10. Then the adhesive material is applied to the outside of the textile of the medium layer 20 next to the bottom surface 12 of the supporting layer 10. The adhesive material remains on the outside of the textile of the medium layer 20 and forms a thin adhesive layer 30. This adhesive layer 30 will adhesive the textile medium layer 20 with the supporting layer 10 enclosed onto the desired portion of the shoe.

FIG. 4 illustrates the process of manufacture the preferred embodiment of the present invention. The process comprises the steps of:

(a) forming a supporting layer;
(b) forming a medium layer on the bottom surface of the supporting layer; and
(c) applying adhesive material on the surface of the medium layer to form a adhesive layer.

In a preferred embodiment, in step (a), the supporting layer is formed with plastic material such as TPE, PU, and EVA, by procedures such as injection molding. In step (b), the TPU material is used to form the medium layer. First the supporting layer is fixed by vacuum at the bottom of the mold with the bottom surface facing up, and the TPU material is injected over the bottom surface and form the medium layer by process such as injection molding. In step (c), the adhesive material or glue is applied on the medium layer to form the adhesive layer, the adhesive material includes but not limited to:

While the embodiments and alternatives of the invention have been shown and described, it will be apparent to one skilled in the art that various other changes and modifications can be made without departing from the spirit and scope of the invention.

What is claimed is:

1. A adherable footwear cushion, comprising:
a supporting layer made of elastic material for absorbing pressure from the foot, wherein having a top surface and a bottom surface;
a medium layer having a first side and a second side, wherein the first side is fixed on the bottom surface of the supporting layer; and
an adhesive layer made of adhesive material combined on the second side of the medium layer, wherein the adhesive layer detachably stick the supporting layer on desired portion of the footwear through the medium layer.

2. The adherable footwear cushion, as recited in claim 1, wherein the elastic material is plastic.

3. The adherable footwear cushion, as recited in claim 2, wherein the elastic material is TPE, PU, or EVA.

4. The adherable footwear cushion, as recited in claim 3, wherein the medium layer is made of TPU.

5. The adherable footwear cushion, as recited in claim 4, wherein the adhesive layer material is pressure sensitive adhesive.

6. The adherable footwear cushion, as recited in claim 5, wherein the adhesive layer material is silicon pressure sensitive adhesive.

7. The adherable footwear cushion, as recited in claim 1, wherein the elastic material is foam.

8. The adherable footwear cushion, as recited in claim 7, wherein the medium layer is made of textile.

9. The adherable footwear cushion, as recited in claim 8, wherein the adhesive layer material is pressure sensitive adhesive.

10. The adherable footwear cushion, as recited in claim 9, wherein the adhesive layer material is silicon pressure sensitive adhesive.

11. A process of manufacturing an adherable footwear cushion, comprising steps of:
forming a supporting layer by a plastic material;
forming a medium layer on the bottom surface of the supporting layer; and
applying adhesive material on the surface of the medium layer to form a adhesive layer.

12. The process of manufacturing an adherable footwear cushion as recited in claim 11, wherein the supporting layer is formed by TPE, PU, or EVA.

13. The process of manufacturing an adherable footwear cushion as recited in claim 12, wherein the medium layer is formed by TPU.

14. The process of manufacturing an adherable footwear cushion as recited in claim 13, wherein the adhesive material is pressure sensitive adhesive.

15. The process of manufacturing an adherable footwear cushion as recited in claim 14, wherein the adhesive material is silicon pressure sensitive adhesive.
